(19) United States
(12) Patent Application Publication
(10) Pub. No.: US 2016/0144704 A1
(43) Pub. Date: May 26, 2016

(54) HYBRID TRANSMISSION WITH AN ADDITIONAL ELECTRIC MACHINE

(71) Applicant: RENAULT S.A.S., Boulogne-Billancourt (FR)

(72) Inventors: Ahmen KETFI-CHERIF, Elancourt (FR); Karima NAIR, Puteaux (FR)

(73) Assignee: RENAULT S.A.S., Boulogne-Billancourt (FR)

(21) Appl. No.: 14/899,967

(22) PCT Filed: May 19, 2014
(86) PCT No.: PCT/FR2014/051148

§ 371 Date: Feb. 9, 2016

(30) Foreign Application Priority Data
Jun. 26, 2013 (FR) 1356127

(51) Int. Cl. B60K 6/485; F16H 3/08; B60K 6/36; F16H 3/00

(52) U.S. Cl. CPC B60K 6/485; F16H 3/006; F16H 3/08; B60K 6/36; Y10S 903/909; B60Y 2200/92

(57) ABSTRACT

A hybrid transmission for a motor vehicle provided with a heat engine and an electric driving machine includes two concentric primary shafts and a first coupling between the two primary shafts able to occupy at least three positions in which the heat engine is uncoupled from the kinematic chain connecting the electric driving machine to the wheels, the heat engine drives the wheels with or without extra contribution from the electric driving machine, and the heat engine and the electric driving machine are coupled so as to add their torques toward the wheels. The transmission also includes a secondary shaft connected to the wheels of the vehicle and supporting a second coupling to connect either of the two secondary pinions on the shaft. The transmission also includes an additional shaft connected to an additional electric machine to supply an engine torque or a resistive torque to the transmission.

The present invention relates to the field of hybrid transmissions.

The present invention relates to a hybrid transmission for a motor vehicle provided with a heat engine and an electric driving machine.

More precisely, this invention relates to a hybrid transmission comprising:
two concentric primary shafts, a first coupling means between the two primary shafts able to occupy at least three positions in which the heat engine is uncoupled from the kinematic chain connecting the electric driving machine to the wheels, the heat engine drives the wheels with or without extra contribution from the electric driving machine, or the heat engine and the electric driving machine are coupled so as to add their torques toward the wheels, and
a secondary shaft connected to the wheels of the vehicle, supporting a second coupling means capable of connecting either of two secondary pinions on said shaft.

Publication WO 2012/131259 discloses a hybrid transmission of the type indicated above, making it possible to provide at least two separate gears in electric and hybrid mode and a higher gear dedicated to quick travel in heat mode. The autonomy of travel of a hybrid vehicle equipped with such a transmission is dependent on the expected performances of the vehicle and on the dimensioning of the components thereof, inclusive of the electric machine.

The dimensioning of electric machines or of batteries of a hybrid vehicle has a direct influence on the overall mass of the vehicle. It is dictated by layout and cost constraints, in particular when the electric machine must function as a generator so as to allow a recharging of the traction battery when the vehicle is stopped.

The present invention aims to increase the autonomy of a hybrid vehicle of which the transmission comprises two concentric primary shafts connected to a heat engine and to an electric driving machine, each supporting at least one step-down pinion on a secondary shaft connected to the wheels of the vehicle.

With this objective, the transmission comprises an additional shaft connected to an additional electric machine, capable of supplying an engine torque or a resistive torque to the transmission.

The additional shaft preferably supports two step-down pinions on the primary shafts, and a third coupling means making it possible to connect in rotation either of these step-down pinions and the additional shaft.

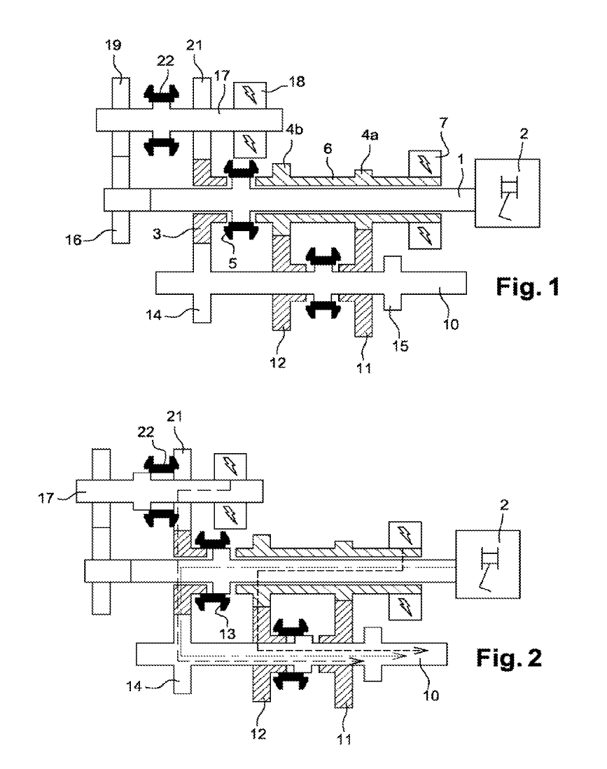

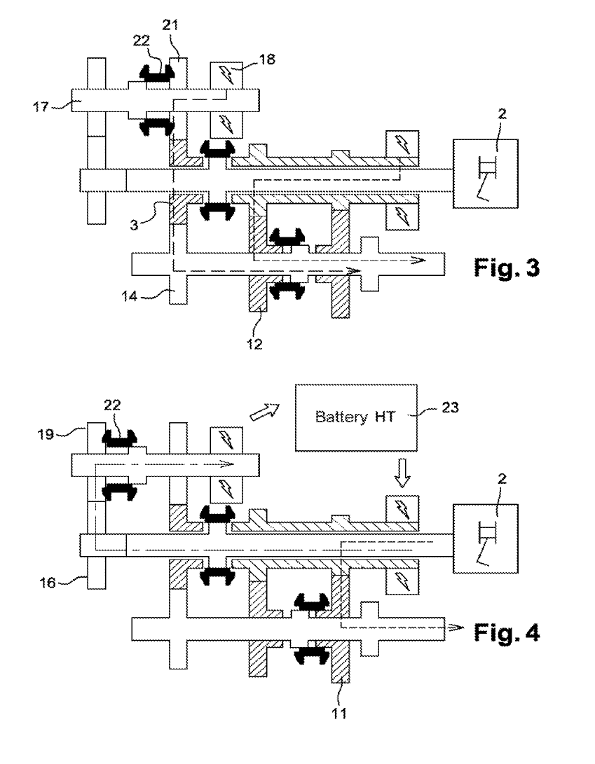

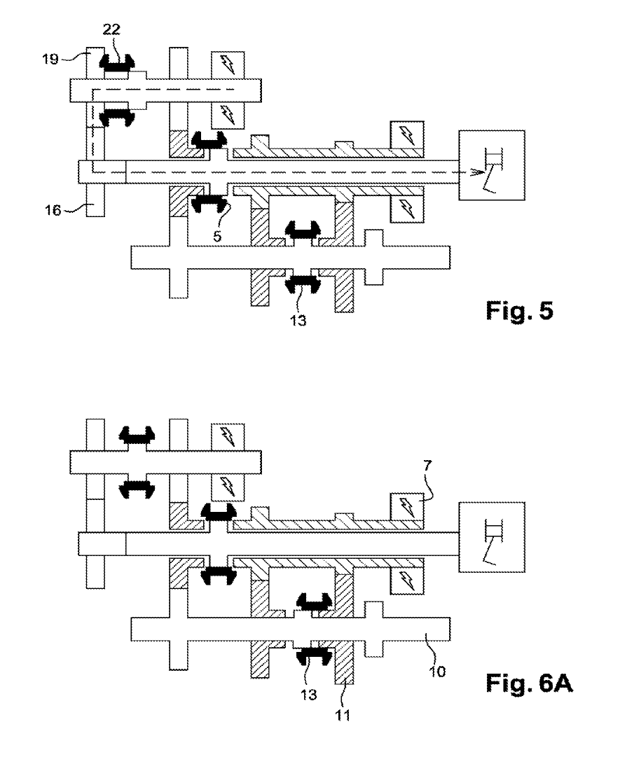

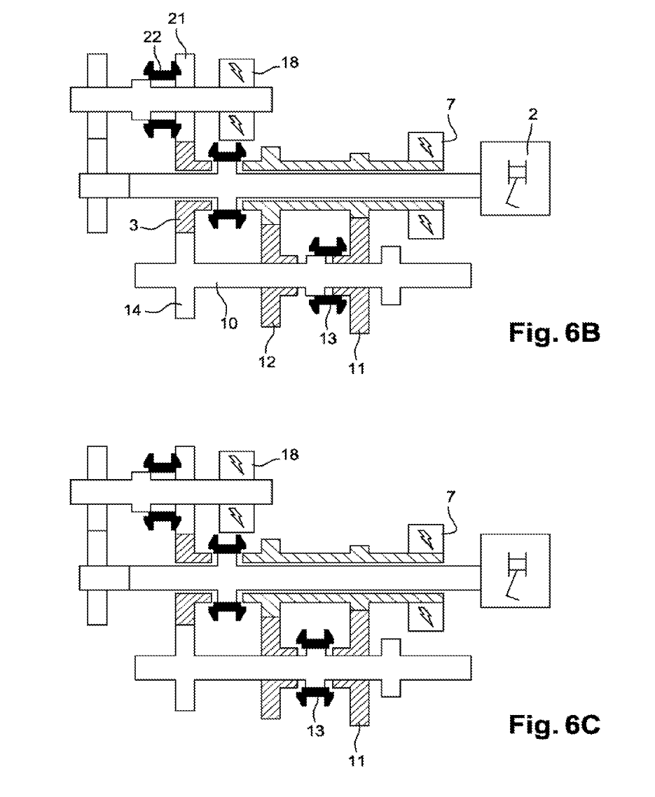

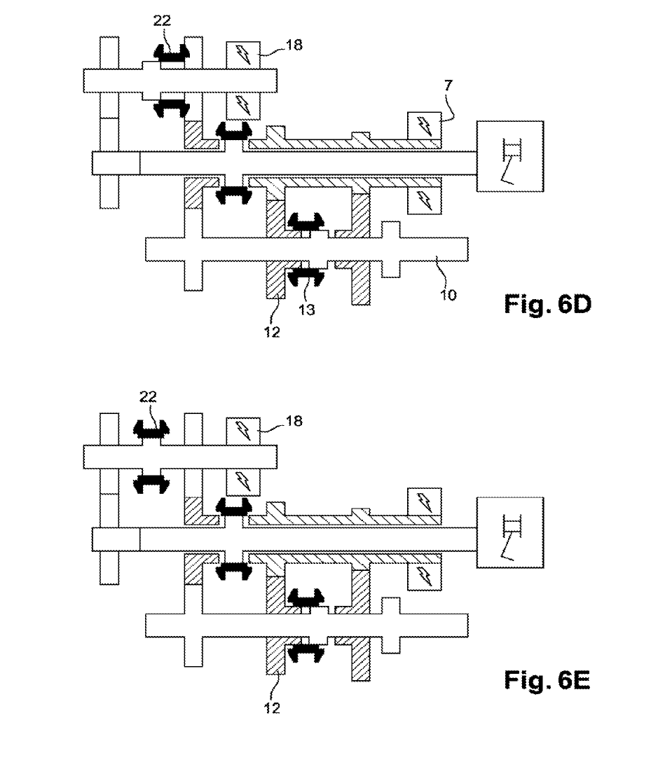

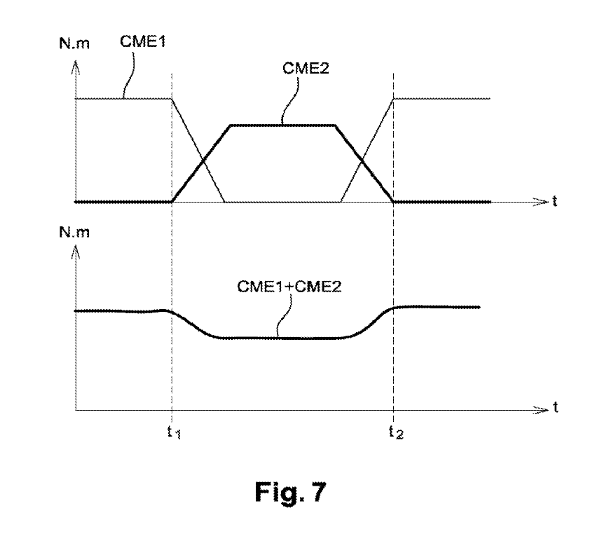

The present invention will be better understood upon reading the following description of a non-limiting embodiment thereof, given with reference to the accompanying drawings, in which a hybrid transmission is shown:
in the neutral position in FIG. 1,
in hybrid mode with “boost” in its long gear in FIG. 2,
in electric mode with “boost” in its intermediate gear in FIG. 3,
in electric mode in the short gear with simultaneous recharge of the battery in FIG. 4,
in a situation of start-up of the heat engine in the long gear in FIG. 5,
in transition from the short gear to the intermediate gear in electric mode in FIGS. 6A to 6E, and
FIG. 7 shows the variation of the torque transmitted to the wheels during a gear change.

The transmission illustrated by the drawings comprises a solid primary shaft 1, connected directly by means of a filtration system (shock absorber hub, “damper”, dual mass or other) to the flywheel of a heat engine 2. The solid shaft 1 supports an idler pinion 3, able to be connected thereto via a first coupling system 5 (dog clutch, synchronizer, or other type of coupler, which may or may not be progressive). A hollow primary shaft 6 is connected to the rotor of a first electric machine, or electric driving machine 7. The hollow shaft 6 can be connected to the solid primary shaft 1 by means of the coupling system 5. A secondary shaft 10 supports two idler pinions 11 and 12. A second coupling system 13 (dog clutch, synchronizer, or other type of coupler, which may or may not be progressive), makes it possible to connect the idler pinions 11, 12 to the hollow primary shaft 6. The secondary shaft 10 also supports a fixed pinion 14 and a step-down pinion 15 toward a differential (not shown) connected to the wheels of the vehicle. Lastly, the primary shaft 1 supports a fixed toothing 16, connected to an additional shaft 17.

The two primary shafts 1, 6 are concentric. The first coupling means 5 may occupy at least three positions, in which:
the heat engine is uncoupled from the kinematic chain connecting the electric machine 7 to the wheels (position 1),
the heat engine drives the wheels with or without extra contribution from the electric machine (position 2), and
the heat engine and the electric machine 7 are coupled so as to add their torques toward the wheels (position 3).

The secondary shaft 10, connected to the wheels of the vehicle, supports a second coupling means 13, which may occupy three positions, in which one of the two secondary pinions 11, 12 or neither thereof is connected to the secondary shaft 10. Without taking the latter into consideration, the three positions of the first coupling means 5 and the combined intervention of the second coupling means 13 ensure that the transmission has three gears: a short gear and an intermediate gear in electric mode, three gears in hybrid mode, and a long gear in heat mode.

The additional shaft 17 is mechanically connected to a second electric machine, or additional machine 18, capable of supplying an engine torque or a resistive torque to the transmission. It supports two idler pinions 19, 21, which are step-down pinions, meshing respectively with a fixed toothing 16 of the primary shaft 1 and with the idler pinion 3 thereof. The first step-down pinion 21 drives a secondary pinion 14 by means of the idler pinion 3 of the solid primary shaft 1. It ensures the transmission of the torque of the additional machine 18 toward the secondary shaft 10. A second step-down pinion 19 ensures the transmission of the torque between the additional machine 18 and the solid primary shaft 1. The additional shaft 17 supports a third coupling means 22 able to connect in rotation either of the step-down pinions 19, 21 and the additional shaft. It can occupy three positions, one of which is a neutral position, and two positions of engagement, in which one of the two idler pinions 19, 21 or neither of them is connected to the additional shaft 17. In neutral (see FIG. 1), the electric machine 18 is disconnected from the transmission. In the right position of the third coupler 22 in the drawings (see FIGS. 2 and 3), it supplies a torque that is applied directly to the secondary shaft 10, connected to the wheel. In its left position of the coupler 22 (see FIGS. 4 and 5) it supplies an additional torque to the heat engine and can also serve to start up said engine more quickly.

In FIG. 2 the transmission is in hybrid mode: the first coupler 5 is in position (2), in which the heat engine 2 is coupled to the wheels. The second coupler 13 connects the pinion 12 to the shaft 10. The third coupler 22 connects the pinion 21 to the additional shaft 22. The second machine 18 supplies an additional torque. The transmission is in hybrid mode in the long gear, referred to as “motorway” gear, with adding of the torques of the heat engine 2 and of the two electric machines 7, 18. The second electric machine 18 thus makes it possible to benefit from a surplus of energy, or “boost”, in this gear, or to optimize the use of the electrical energy by means of an optimal distribution of the torque between the two electric machines.

In FIG. 3 the transmission is in electric mode. The first coupler 5 is in neutral (position 0). The second coupler 13 connects the pinion 12 to the shaft 10. The third coupler 22 connects the pinion 21 to the additional shaft 17. The transmission is in electric mode in the intermediate gear, or “road” gear, with electric “boost”. The short electric gear or the short and intermediate hybrid gears may also benefit from the “boost” of the additional machine 18. The torque of the additional electric machine 18 may thus be added to that of the driving machine 7 in all the gears of the hybrid or electric modes of the transmission.

FIG. 4 shows another use of the second machine 18 for recharging the battery 23 in a recharge mode. The first coupler 5 is in neutral (position 0). The second coupler 13 connects the pinion 11 to the secondary shaft. The third coupler is in the left position in the drawing, in which it connects the solid primary shaft 1 to the additional shaft 17 via the pinions 16 and 19. The second electric machine 18 makes it possible to transform the recharge mode into series hybrid mode enabling travel of the vehicle with increased autonomy in the case of an empty traction battery. The heat engine 2 is connected to the additional machine 18. The battery 23 is recharged by this machine, functioning as a generator. One of the advantages of the proposed architecture thus lies in the possibility of using the first electric machine 7 to drive the vehicle, whereas the additional machine 22, driven by the heat engine 2, functions as a generator. It is thus possible to place the transmission at beneficial yield points for the heat engine (for example at approximately 2000 revolutions per minute) and to turn the wheels at very low speed, since it is the electric driving machine 7 that turns the wheels.

FIG. 5 shows another operating mode. The transmission is here in heat mode purely in the long gear (first coupler 5 in position 1, and second coupler 13 in neutral). The third coupler 22 is in the left position, in which it connects the additional shaft 17 to the solid primary shaft 1 via the pinions 19 and 16. The torque of the additional machine 18 is sent to the heat engine 2 to start said engine. The torque of the additional electric machine 18 makes it possible to perform an ultra-quick start-up of the heat engine, in particular whilst the vehicle is traveling.

The proposed measures offer further possibilities for operation of the hybrid transmissions in question. They make it possible in particular to perform powershifts during transitions between the gears in electric mode or hybrid mode. The appeal is thus improved further. This benefit is demonstrated in an example in FIGS. 6A to 6E, illustrating the case of a shift between an “electric town” mode and an “electric road” mode.

In FIG. 6A only the second coupler 13 is closed, connecting the hollow primary shaft 10 to the secondary pinion of the first gear 11. The transmission is in the short gear in electric mode. In FIG. 6B the additional electric machine 22 is engaged, thanks to the coupling of the additional shaft 17 and the secondary shaft via the third coupler 22 in the right position. The step-down of pinions 21, 3 and 14 is used. The second coupler 13 can thus be placed in neutral (FIG. 6C), then shifted to the left to connect the secondary pinion of the intermediate gear 12 to the shaft 10 (FIG. 6D) whilst still benefitting from the torque of the additional machine 18, before disconnecting same (FIG. 6E). The loss of torque associated with the temporary disconnection of the electric driving machine 7 during the transition is compensated for by the additional machine 18. The assistance of the additional machine 18 may benefit, under similar conditions, the reverse transition (shift from the intermediate gear to the short gear in electric mode), or shifts between the short and intermediate hybrid modes.

FIG. 7 illustrates the profile of the overall torque during this transition. It can be seen how the torque CME2 of the additional machine 18 compensates for the temporary interruption of the torque CME1 supplied by the driving machine 7 during the corresponding period of transition (t1, t2) enabling the second coupler 13.

1-9. (canceled)

10: A hybrid transmission for a motor vehicle provided with a heat engine and an electric driving machine, comprising:
two concentric primary shafts, a first coupling means between the two primary shafts able to occupy at least three positions in which the heat engine is uncoupled from the kinematic chain connecting the electric driving machine to the wheels, the heat engine drives the wheels with or without extra contribution from the electric driving machine, and the heat engine and the electric driving machine are coupled so as to add their torques toward the wheels;
a secondary shaft connected to the wheels of the vehicle, supporting a second coupling means capable of connecting either of the two secondary pinions on said shaft; and
an additional shaft connected to an additional electric machine, capable of supplying an engine torque or a resistive torque to the transmission.

11: The hybrid transmission as claimed in claim 10, wherein the additional shaft supports two step-down pinions on the primary shafts, and a third coupling means making it possible to connect in rotation either of these step-down pinions and the additional shaft.

12: The hybrid transmission as claimed in claim 11, wherein a first step-down pinion ensures the transmission of the torque from the additional electric machine toward the secondary shaft.

13: The hybrid transmission as claimed in claim 12, wherein the first step-down pinion drives a secondary pinion by means of an idler pinion rotating on a solid primary shaft.

14: The hybrid transmission as claimed in claim 11, wherein a second step-down pinion assures the transmission of the torque between the additional electric machine and the solid primary shaft connected to the heat engine.

15: The hybrid transmission as claimed in claim 10, wherein the torque of the additional electric machine is added to that of the driving machine in all the gears of the hybrid or electric modes of the transmission.

16: The hybrid transmission as claimed in claim 10, wherein the additional electric machine functions as a generator in order to transform the motor energy of the heat engine into electrical energy for recharging the battery of the vehicle.

17: The hybrid transmission as claimed in claim 10, wherein the torque of the additional electric machine is used to start up the heat engine.

18: The hybrid transmission as claimed in claim 17, wherein the torque of the additional electric machine is used to start up the heat engine when the vehicle is traveling.

19: The hybrid transmission as claimed in claim 10, wherein the additional electric machine is used to compensate for the interruption of the torque of the electric driving machine during gear transitions in electric and hybrid modes.
